(19) United States
(12) Patent Application Publication
(10) Pub. No.: US 2024/0058834 A1
(43) Pub. Date: Feb. 22, 2024

(54) Die Coater for Coating Current Collector of Secondary Battery with Active Material

(71) Applicant: LG Energy Solution, Ltd., Seoul (KR)

(72) Inventors: Joon Sun Park, Daejeon (KR); Man Hyeong Kim, Daejeon (KR); Min Hyuck Choi, Daejeon (KR); Guk Tae Kim, Daejeon (KR)

(73) Assignee: LG Energy Solution, Ltd., Seoul (KR)

(21) Appl. No.: 18/275,845

(22) PCT Filed: Jan. 9, 2023
(86) PCT No.: PCT/KR2023/000366

§ 371 Date: Aug. 4, 2023

(30) Foreign Application Priority Data
Jan. 11, 2022 (KR) 10-2022-0004219

(51) Int. Cl. B05C 5/02; H01M 4/04

(52) U.S. Cl. CPC B05C 5/0254; H01M 4/0404

(57) ABSTRACT

A die coater capable of effectively simultaneously coating a current collector with two types of different liquids, which includes an upper block provided with a second liquid inlet, a lower block coupled to the upper block and provided with a manifold configured to accommodates a first liquid, and coater shims interposed between the upper block and the lower block to form a first slit and a second slit which are separated from each other. The coater shims include a first coater shim which forms a first slit for discharging the first liquid accommodated in the manifold and a second coater shim which forms a second slit for discharging the second liquid supplied through the second liquid inlet. The first coater shim and the second coater shim have the same height, do not overlap vertically, and are placed on the same surface between the upper block and the lower block.

### CROSS-REFERENCE TO RELATED APPLICATIONS

The present application is a national phase entry under 35 U.S.C § 371 of International Application No. PCT/KR2023/000366 filed on Jan. 9, 2023, which claims the benefit of priority based on Korean Patent Application No. 10-2022-0004219 dated on Jan. 11, 2022, and all contents of which are incorporated herein by reference.

### TECHNICAL FIELD

The present disclosure relates to a die coater capable of effectively simultaneously coating a current collector for a secondary battery with two types of different liquids.

### BACKGROUND ART

As the technology development and the demand for mobile devices increase, the demand for secondary batteries is also rapidly increasing. Among secondary batteries, lithium secondary batteries are widely used as energy sources for various electronic products as well as various mobile devices in terms of high energy density, a high operating voltage, and excellent storage and lifetime characteristics.

A lithium secondary battery employs an electrode in which an active material layer and an insulating layer are formed on a surface of a current collector. The electrode is manufactured using a coating device such as a die coater such that both of an electrode slurry containing an active material and an insulation coating liquid containing an insulating material are applied onto the surface of the current collector to overlap a portion of a corner of an electrode mixture layer and then dried.

FIG. 1 shows a conventional die coater 1 for applying an electrode slurry. The die coater 1 includes an upper block 2 and a lower block 3, and a shim 4 for a die coater is interposed between the upper block 2 and the lower block 3, and the upper block 2, the lower block 3, and the shim 4 are fastened and coupled to each other using a plurality of bolt members. The lower block 3 is provided with a manifold 5 for accommodating a predetermined volume of an electrode slurry, and the manifold 5 communicates with an external electrode slurry supply part (not shown).

Here, the shim for a die coater serves to form a slit with an appropriate height between the upper block and the lower block and, simultaneously, to limit a flow direction of the electrode slurry to discharge the electrode slurry toward the slit and serves to seal between the upper block and the lower block to prevent the electrode slurry from leaking to other portions excluding the slit. The shim for a die coater is provided with guides protruding from both ends in a width direction, and a width of the electrode slurry applied onto the current collector depends on a distance between the guides.

The insulation coating liquid is applied to both sides in the width direction of the electrode slurry applied onto the current collector in the width direction. Generally, after the electrode slurry is applied onto the current collector, the insulation coating liquid is applied through an additional process using a separate device. However, it is not desirable in terms of production efficiency to coat the current collector with the electrode slurry and the insulation coating liquid through separate processes.

In order to overcome the above limitation, a technology for forming independent slits for discharging an electrode slurry and an insulation coating liquid in one die coater core has been introduced. However, when either one of the liquids of the two types of liquids leaks in the die coater, the two types of liquids (e.g., the electrode slurry and the insulation coating liquid) are mixed, or are mixed and discharged from an outlet of a slit, and thus a problem of causing a defect in quality of the current collector occurs.

### DISCLOSURE

### Technical Problem

The present disclosure is directed to providing a die coater capable of effectively simultaneously coating a current collector for a secondary battery with two types of different liquids.

However, the technical problems to be solved by the present invention are not limited to the above-described problem, and other problems not mentioned can be clearly understood by those skilled in the art from the following description of the present invention.

### Technical Solution

One aspect of the present invention provides a die coater capable of effectively simultaneously coating a current collector for a secondary battery with two types of different liquids, which includes an upper block provided with a second liquid inlet, a lower block coupled to the upper block and provided with a manifold configured to accommodates a first liquid, and coater shims interposed between the upper block and the lower block to form a first slit and a second slit which are separated from each other, wherein the coater shims include a first coater shim which forms a first slit for discharging the first liquid accommodated in the manifold and a second coater shim which forms a second slit for discharging the second liquid supplied through the second liquid inlet, and the first coater shim and the second coater shim have the same height, do not overlap vertically, and are placed on the same surface between the upper block and the lower block.

A width of the first slit may be by a width of the second coater shim.

A height of the first slit may correspond to the height of the first coater shim, and a height of the second slit may be formed to be smaller than the height of the second coater shim.

The second coater shim may be provided with a concave flow path groove which opens toward the upper block and has a bottom surface, a closed end of the flow path groove may be connected to the second liquid inlet of the upper block, and an open end of the flow path groove may form the second slit.

The first coater shim may include a base extending in a width direction and first and second guides extending to protrude from both ends of the base, and a side walls of the second coater shim may be in close contact with inner walls of the first and second guides.

A distance between a pair of the other side walls of the second coater shim may correspond to the width of the first slit.

A screw through-hole to access a bottom surface of the second coater shim may be formed in the lower block, and an end portion of a bolt screw-coupled to the screw through-hole may pressurize the second coater shim such that the second coater shim is in close contact with the upper block.

An expanded pressurizing block hole may be formed at an end portion of the screw through-hole in a coupling direction, and a pressurizing block accommodated in the pressurizing block hole may be interposed between the bolt and the second coater shim to pressurize the second coater shim.

The pressurizing block may pressurize portions of both side walls of the second coater shim.

The die coater may further include a third coater shim which is provided with a concave U-shaped flow path groove which opens toward the upper block and has a bottom surface, in which a closed end of the U-shaped flow path groove is connected to the second liquid inlet of the upper block and two open ends of the U-shaped flow path groove form third slits, and which has a height that is equal to the height of each of the first and second coater shims, wherein the third coater shim may be disposed between the first and second guides.

A screw through-hole to access to a bottom surface of the third coater shim may be formed in the lower block, and an end portion of a bolt screw-coupled to the screw through-hole may pressurize the third coater shim such that the third coater shim is in close contact with the upper block.

An expanded pressurizing block hole may be formed at an end portion of the screw through-hole in a coupling direction, and a pressurizing block accommodated in the pressurizing block hole may be interposed between the bolt and the third coater shim to pressurize the third coater shim.

The pressurizing block may pressurize portions of both side walls of the third coater shim.

### Advantageous Effects

In accordance with a die coater of the present disclosure, the die coater is formed to simultaneously discharge two different liquids, for example, an electrode slurry and an insulation coating liquid. In particular, a first slit and a second slit, which discharge the first liquid and the second liquid, respectively, can be physically separated from each other in the die coater.

In addition, since a second coater shim forming the second slit maintains airtightness using a separate pressurizing structure, internal mixing of the first liquid and the second liquid can be reliably prevented.

Therefore, in accordance with the die coater of the present disclosure, it is possible to effectively simultaneously coat a current collector with two types of different liquids.

It should be noted that effects of the present invention are not limited to the above described effect, and other effects of the present invention not mentioned above can be clearly understood by those skilled in the art from the following detailed description.

### DESCRIPTION OF DRAWINGS

However, the following drawings attached to the present specification illustrate exemplary embodiments of the present invention and serve to further assist understanding of the technical idea of the present invention together with the detailed description of the present invention, which will be described below, and thus the present invention should not be construed as being limited to details shown in the accompanying drawings.

FIG. 1 is a diagram illustrating a configuration of a die coater according to the related art.

FIG. 2 is an exploded perspective view illustrating a die coater according to one embodiment of the present invention.

FIG. 3 is a plan view illustrating the die coater through an upper block.

FIG. 4 is an enlarged front view illustrating part “A” of FIG. 3.

FIG. 5 is an enlarged front view illustrating part “B” of FIG. 3.

FIG. 6 is an exploded perspective view illustrating a die coater according to another embodiment of the present invention.

FIG. 7 is a perspective view illustrating a third coater shim included in the die coater of FIG. 6.

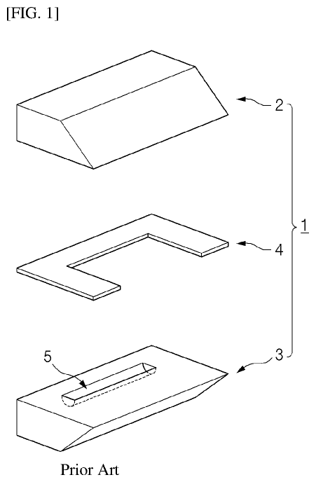

### DETAILED DESCRIPTION

The present invention may be modified into various forms and may have a variety of embodiments, and, therefore, specific embodiments will be described in detail below.

However, the embodiments are not to be taken in a sense which limits the present invention to the specific embodiments and should be construed to include all modifications, equivalents, or substituents falling within the spirit and technical scope of the present invention.

In the present invention, the terms “comprising,” “having,” and the like are used to specify the presence of a feature, a number, a step, an operation, a component, an element, or a combination thereof described herein, and they do not preclude the presence or addition of one or more other features, numbers, steps, operations, components, elements, or combinations thereof.

In addition, in the present invention, when a portion of a layer, a film, a region, a plate, or the like is described as being “on” another portion, this includes not only a case in which the portion is “directly on” another portion but also a case in which still another portion is present between the portion and another portion. Conversely, when a portion of a layer, a film, a region, a plate, or the like is described as being “under” another portion, this includes not only a case in which the portion is “directly under” another portion, but also a case in which still another portion is present between the portion and another portion. In addition, in the present application, as being disposed “on” may include the case of being disposed not only on an upper portion but also on a lower portion.

Embodiment of the present invention relates to a die coater capable of effectively simultaneously coating a current collector for a secondary battery with two types of different liquids.

In one example, the die coater of an embodiment of the present invention includes an upper block provided with a second liquid inlet, a lower block coupled to the upper block and provided with a manifold which accommodates a first liquid, and coater shims interposed between the upper block and the lower block to form a first slit and a second slit which are separated from each other.

Here, the die coater of an embodiment of the present invention includes two types of the coater shims including a first coater shim and a second coater shim. The first coater shim forms the first slit which discharges the first liquid accommodated in the manifold of the lower block, and the second coater shim forms the second slit which discharges a second liquid supplied through a second liquid inlet of the upper block. In particular, the first coater shim and the second coater shim have the same height and do not vertically overlap, and thus the first and second coater shims are placed on the same surface between the upper block and the lower block.

According to the die coater of an embodiment of the present invention, the die coater is formed to simultaneously discharge two different liquids, for example, an electrode slurry and an insulation coating liquid. In particular, since the first slit and the second slit, which discharge the first liquid and the second liquid, respectively, are physically separated from each other in the die coater, an internal mixing of the first liquid and the second liquid can be prevented.

### Modes of the Invention

Hereinafter, some embodiments of a die coater according to the present invention will be described in detail with reference to the accompanying drawings.

### First Embodiment

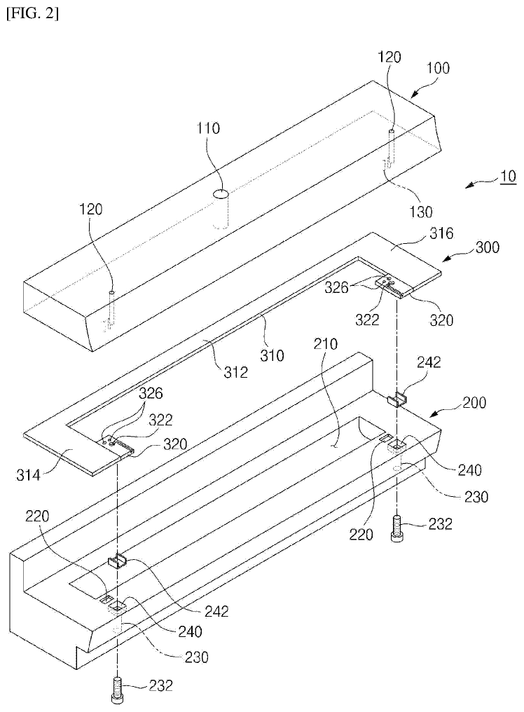

FIG. 2 is an exploded perspective view illustrating a die coater 10 according to one embodiment of the present invention. Referring to FIG. 2, the overall configuration of the die coater 10 according to an embodiment of the present invention will be described as follows.

As described above, embodiments of the present invention relates to a die coater 10 capable of effectively simultaneously coating a current collector for a secondary battery with two types of different liquids. The two types of different liquids may be, for example, an electrode slurry and an insulation coating liquid. The following description can be understood as an embodiment in which a first liquid is the electrode slurry and a second liquid is the insulation coating liquid.

The die coater 10 of embodiments of the present invention includes an upper block 100, a lower block 200, and a coater shim 300 interposed therebetween. In particular, the coater shim 300 in an embodiment of the present invention includes a first coater shim 310 and a second coater shim 320.

The upper block 100 is a part which includes a second liquid inlet 120 and occupies approximately half of a body of the die coater 10. The lower block 200 is a part which occupies the remaining half coupled to the upper block 100 and is provided with a manifold 210 which accommodates the first liquid. Here, upper and lower portions are divided on the basis of the drawings and do not limit an actual installation direction of the die coater 10.

For reference, FIG. 2 shows a first liquid inlet 110 that is formed in the upper block 100 communicating with the manifold 210 of the lower block 200, but the first liquid inlet 110 may be formed in the lower block 200. On the other hand, the second liquid inlet 120 should be formed in the upper block 100. This is because an arrangement design is limited due to a flow path groove 322 formed in the second coater shim 320 and its airtight structure, which will be described below.

The coater shim 300 is interposed between the upper block 100 and the lower block 200. The coater shim 300 is basically interposed between the upper block 100 and the lower block 200 to form a slit with a height suitable for discharging a liquid. In addition, the coater shim 300 limits a flow direction of a liquid, which flows into the die coater 10 or is accommodated in the die coater 10, to be discharged toward the slit without a backflow and also serves to seal the liquid so as not to leak to other parts excluding the slit.

In an embodiment of the present invention, the first coater shim 310 and the second coater shim 320 are included as the coater shim 300. The first coater shim 310 and the second coater shim 320 form a first slit 318 and a second slit 328 which are separated. Specifically, the first coater shim 310 forms the first slit 318 which discharges the first liquid accommodated in the manifold 210 of the lower block 200, and the second coater shim 320 forms the second slit 328 which discharges the second liquid supplied through the second liquid inlet 120 of the upper block 100.

In addition, the first coater shim 310 and the second coater shim 320 have the same height and do not overlap vertically. Therefore, the first coater shim 310 and the second coater shim 320 are placed on the same surface between the upper block 100 and the lower block 200.

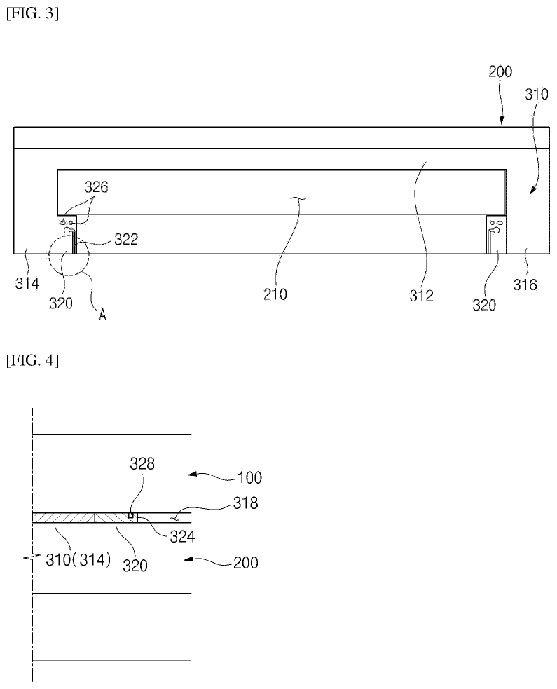

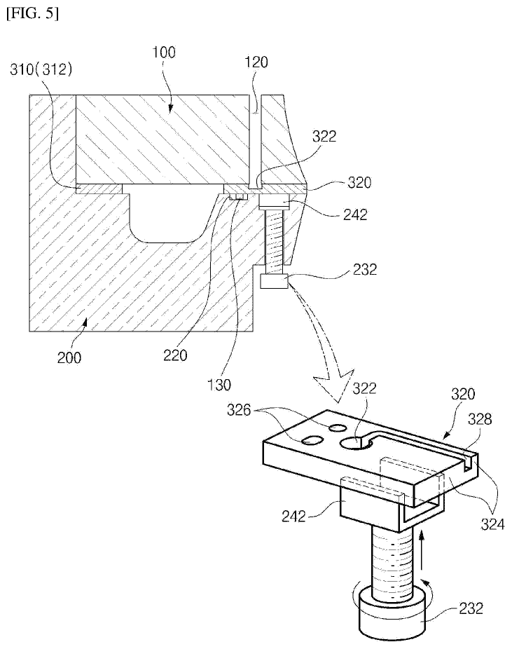

FIG. 3 is a plan view illustrating the die coater 10 without the upper block 100, and FIG. 4 is an enlarged front view illustrating part “A” of FIG. 3. Referring to FIGS. 3 and 4, the first coater shim 310 includes a base 312 extending in a width direction, and a first guide 314 and a second guide 316 which protrude to extend from both ends of the base 312. In addition, the second coater shim 320 is provided with a concave flow path groove 322 which opens toward the upper block 100 and has a bottom surface (see FIG. 5).

Here, in the first coater shim 310, a space between the first and second guides 314 and 316 forms the first slit 318, and in the second coater shim 320, an open end of the concave flow path groove 322 having the bottom surface forms the second slit 328. Since a depth of the flow path groove 322 is smaller than a thickness (height) of the second coater shim 320, as shown in FIG. 4, a height of the first slit 318 corresponds to the height of the first coater shim 310, and a height of the second slit 328 is formed to be smaller than the height of the second coater shim 320.

In addition, since the first coater shim 310 and the second coater shim 320 have the same height and are coplanar with each other without overlapping vertically, a width of the first slit 318 is limited by a width of the second coater shim 320.

For example, in the first embodiment shown in FIG. 3, a pair of one side walls 324 of the second coater shims 320 are in close contact with inner walls of the first guide 314 and the second guide 316. Therefore, a distance between a pair of the other side walls 324 of the second coater shims 320, which face each other, (side surfaces opposite to sidewalls in close contact with each other) corresponds to an actual width of the first slit 318. That is, a length obtained by subtracting the width of the second coater shim 320 from the distance between the inner walls of the first guide 314 and the second guide 316 becomes the width of the first slit 318.

As described above, looking at a structure of the second slit 328 formed by the second coater shim 320, since the first liquid of the first slit 318 is blocked by the both side walls 324 of the second coater shim 320, and a lower side of the flow path groove 322 is the bottom surface and an upper side thereof is in close contact with the upper block 100, the second coater shim 320 is structurally completely separated from the first liquid. Therefore, in the die coater 10 according to an embodiment of the present invention, a probability of mixing the two types of different liquids is significantly reduced.

In addition, according to an embodiment of the present invention, improved airtightness of the second coater shim 320 can be maintained by a pressurizing structure shown in FIG. 5. The pressurizing structure of FIG. 5 is to reinforce the airtightness between the upper block 100 and the second coater shim 320. That is, since both side surfaces and the bottom surface of the first coater shim 310 are a closed structure securing the airtightness, the airtightness of the upper surface is affected by a degree of adhesion to the upper block 100. Accordingly, the pressurizing structure of FIG. 5 is applied to bring the second coater shim 320 more firmly in close contact with the upper block 100.

Referring to FIG. 5, a closed end of the concave flow path groove 322 formed in the second coater shim 320 is connected to the second liquid inlet 120 of the upper block 100 to receive the second liquid. For reference, as shown in FIG. 2, the number and positions of second liquid inlets 120 correspond to the number and positions of second coater shims.

In addition, in the illustrated embodiment, an installation position of the second coater shim 320 is accurately set by a pin member 130 provided in the upper block 100. The pin member 130 protrudes from near the second liquid inlet 120 and is inserted into a coupling hole 326 provided in the second coater shim 320 so that the position of the second coater shim 320 is fixed.

Here, the pin member 130 and the coupling hole 326 may be designed such that a fixing position and a direction of the second coater shim 320 are consistently determined. Specifically, an installation direction should be consistently determined so that the second coater shim 320 receiving the inserted pin member 130 is prevented from being rotated. This may be achieved through design of a structure providing a plurality of pin members 130, a structure forming the pin member 130 and the coupling hole 326 in shapes excluding a circular cross section, or combining these structures. In addition, if necessary, a concave pin insertion hole 220 for accommodating the protruding pin member 130 may be provided in the lower block 200.

A screw through-hole 230 to access to the bottom surface of the second coater shim 320 is formed in the lower block 200, and an end portion of a bolt 232 screw-coupled to the screw through-hole 230 presses the second coater shim 320 so that the upper surface of the second coater shim 320 is more strongly pressed against the upper block 100.

In addition, in order to more effectively press the second coater shim 320 to the upper block 100, an expanded pressurizing block hole 240 is formed at an end portion of the screw through-hole 230 in a coupling direction of the screw through-hole 230 (a direction in which the bolt is tightened), and a pressurizing block 242 accommodated in the pressurizing block hole 240 is interposed between the bolt 232 and the second coater shim 320, and thus the second coater shim 320 can be pressurized more efficiently. For example, the pressurizing block 242 pressurizes portions of the both side walls 324 of the second coater shim 320, and thus the second coater shim 320 can be pressurized more efficiently.

In addition to the pressurizing structure prepared separately from the second coater shim 320, that is, the pressurizing force generated by mutual engagement of the upper block 100 and the lower block 200, due to an additional pressurizing force by which the bolt 232 pressurizes the second coater shim 320, a probability that the second liquid flowing through the second coater shim 320 is mixed with the first liquid around the second liquid becomes extremely low.

### Second Embodiment

The second embodiment of the present invention is an embodiment suitable for a case in which a first liquid and a second liquid, for example, an electrode slurry and an insulation coating liquid, are applied onto a current collector provided in the form of a coil in two or more rows, and then a slitting process is performed.

That is, the second embodiment corresponds to an embodiment suitable for simultaneously coating the current collector with an active material to have a structure of “insulation coating liquid—electrode slurry—insulation coating liquid” in two or more rows.

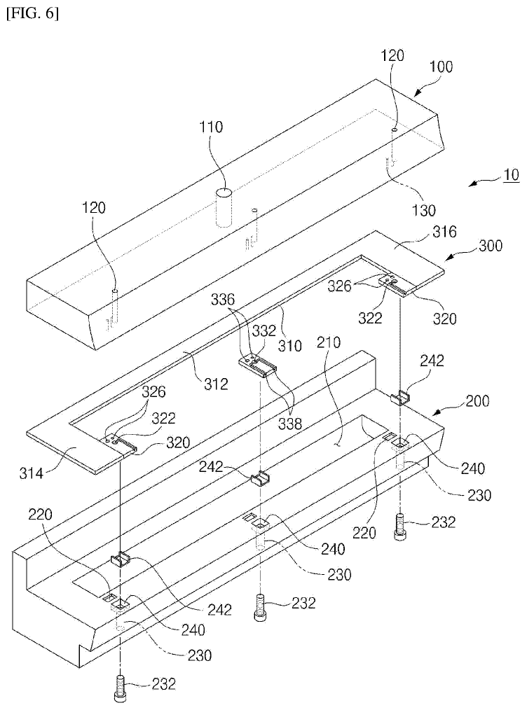

FIG. 6 is an exploded perspective view illustrating a die coater 10 according to another embodiment of the present invention, and the second embodiment includes the entire structure of the first embodiment and further includes a third coater shim 330. The third coater shim 330 is installed in the middle of the die coater 10 in the width direction and discharges the second liquid in two streams through a U-shaped flow path groove 332. That is, the third coater shim 330 is formed to discharge the second liquid in two streams corresponding to both second coater shims 320 disposed in close contact with the first and second guides 314 and 316.

In addition, the third coater shim 330 is disposed between the first and second guides 314 and 316 of the first coater shim 310. As the second coater shim 320 limits the actual width of the first slit 318, the third coater shim 330 also serves as a factor for limiting the first slit 318. Therefore, the third coater shim 330 disposed in the middle of the first slit 318 divides the first liquid into two liquids to discharge the first liquid in two rows in parallel. A height of the third coater shim 330 corresponds to the heights of the first and second coater shims 310 and 320.

Due to the arrangement of the third coater shim 330 and the two-row discharge structure of the second liquid, the coating structure of “second liquid—first liquid—second liquid” is formed on the current collector in two rows in parallel in a length direction of the current collector, and two current collector rolls may be obtained by performing a slitting process by which a portion between the two rows in parallel is cut.

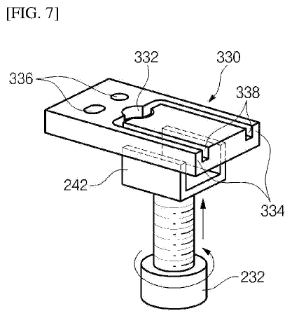

FIG. 7 is a perspective view illustrating the third coater shim 330 which has the same configuration as the second coater shim 320 except for the structure of the U-shaped flow path groove 332. Specifically, the third coater shim 330 is provided with the concave U-shaped flow path groove 332 which opens toward the upper block 100 and has a bottom surface. A closed end of the U-shaped flow path groove 332 is connected to the second liquid inlet 120 of the upper block 100, and two open ends of the U-shaped flow path groove 332 form third slits 338. Similarly, a coupling hole 336 is inserted into a pin member 130 so that a position of the third coater shim 330 is fixed and does not rotate.

Also, the same pressurizing structure as the second coater shim 320 may be applied onto the third coater shim 330, and a configuration and operation of the third coater shim 330 are the same as those described above. That is, a screw through-hole 230 to access to the bottom surface of the second coater shim 320 is formed in the lower block 200, and an end portion of a bolt 232 screw-coupled to the screw through-hole 230 pressurizes the third coater shim 330 such that the third coater shim 330 is in close contact with the upper block 100.

In addition, an expanded pressurizing block hole 240 is formed at an end portion of the screw through-hole 230 in a coupling direction, and a pressurizing block 242 accommodated in the pressurizing block hole 240 is interposed between the bolt 232 and the third coater shim 330, and thus the third coater shim 330 can be pressurized, for example, the pressurizing block 242 can pressurize portions of side walls 334 of the third coater shim 330.

Here, in the second embodiment, although it is described that the first liquid and the second liquid are simultaneously applied onto the electrode part in two rows in parallel by adding one third coater shim 330, it can be obviously understood by those skilled in the art that two or more third coater shims 330 may be added and thus the first liquid and the second liquid may be applied in three or more rows.

As described above, the present invention has been described in more detail with reference to the accompanying drawings and the embodiments. Therefore, the configurations described herein or shown in the drawings are merely one embodiment of the present invention and do not represent all the technical spirit of the present invention such that it should be understood that there may be various equivalents and modifications capable of substituting the embodiments and the configurations at the time of filing the present application.

[Description of Reference
Numerals]
10: die coater
100: upper block
110: first liquid inlet
120: second liquid inlet
130: pin member
200: lower block
210: manifold
220: pin insertion hole
230: screw through-hole
232: bolt
240: pressurizing block hole
242: pressurizing block
300: coater shim
310: first coater shim
312: base
314: first guide
316: second guide
318: first slit
320: second coater shim
322: flow path groove
324: sidewall
326: coupling hole
328: second slit
330: third coater shim
332: U-shaped flow path groove
334: sidewall
336: coupling hole
338: third slit

### INDUSTRIAL APPLICABILITY

The die coater of the present disclosure is useful for effectively and simultaneously coating the current collector for the secondary battery with two types of different liquids.

1. A die coater comprising:
an upper block having a plurality of second liquid inlets;
a lower block coupled to the upper block, wherein the lower block includes a manifold configured to accommodates a first liquid; and
a plurality of coater shims interposed between the upper block and the lower block to form a first slit and a second slit, wherein the first slit and the second slit are spaced apart from each other,
wherein the plurality of coater shims include a first coater shim and a second coater shim, wherein the first coater shim includes the first slit configured to discharge the first liquid accommodated in the manifold and the second coater shim includes the second slit configured to discharge a second liquid supplied through an at least one of the plurality of second liquid inlets, and
wherein the first coater shim and the second coater shim have a same height, do not overlap vertically, and are disposed on a same surface between the upper block and the lower block.

2. The die coater of claim 1, wherein a width of the first slit is determined by a width of the second coater shim.

3. The die coater of claim 2, wherein:
a height of the first slit is the same as the height of the first coater shim; and
a height of the second slit is smaller than the height of the second coater shim.

4. The die coater of claim 3, wherein:
the second coater shim includes:
a recessed concave flow path groove disposed to face the upper block and has a bottom surface;
a closed end of the recessed concave flow path groove being connected to the at least one of the plurality of the second liquid inlets of the upper block; and
an open end of the recessed concave flow path groove that forms the second slit.

5. The die coater of claim 4, wherein:
the first coater shim includes a base extending in a width direction and first and second guides protruding from both ends of the base, wherein the first guide and the second guide extend perpendicular to the width direction of the base; and
a pair of first side walls of the second coater shim contact an inner walls of each of the first and second guides,
wherein the pair of the first side walls of the second coater shim are disposed to face an exterior region of the die coater in the width direction, and
wherein the inner wall of each of the first and second guides is disposed to face a central region of the die coater in the width direction.

6. The die coater of claim 5, wherein a distance between a pair of second side walls of the second coater shim determines a width of the first slit, wherein the pair of second sidewalls of the second coater shim are disposed to face the central region of the die coater shim in the width direction;
wherein the pair of second sidewalls of the second coater shim are disposed closer to the central region than the inner walls of each of the first and second guides.

7. The die coater of claim 1, wherein:
a screw through-hole is disposed in the lower block, so at to provide access to a bottom surface of the second coater shim; and
an end portion of a bolt screw-coupled to the screw through-hole is configured to pressurize the second coater shim, so as to bring the second coater shim in close contact with the upper block.

8. The die coater of claim 7, wherein:
an expanded pressurizing block hole is disposed at an end portion of the screw through-hole in a coupling direction, wherein the coupling direction is perpendicular to the width direction of the base; and
a pressurizing block accommodated in the expanded pressurizing block hole is interposed between the bolt and the second coater shim, wherein the pressurizing block is configured to pressurize the second coater shim.

9. The die coater of claim 8, wherein the pressurizing block is configured to pressurizes portions of both side walls of the second coater shim.

10. The die coater of claim 5, further comprising:
a third coater shim disposed between each of the each of the first and second guides,
wherein the third coater shim includes:
a recessed concave U-shaped flow path groove disposed to face the upper block and has a bottom surface,
a closed end of the recessed U-shaped flow path groove is being connected to the at least one of the second liquid inlets of the upper block,
two open ends of the recessed U-shaped flow path groove form third slits, and
wherein the third coater shim has a height that is equal to the height of each of the first and second coater shims.

11. The die coater of claim 10, wherein:
a screw through-hole is disposed in the lower block, so as to provide to access to a bottom surface of the third coater shim; and
an end portion of a bolt screw-coupled to the screw through-hole is configured to pressurizes the third coater shim, so as to bring the third coater shim is in close contact with the upper block.

12. The die coater of claim 11, wherein:
an expanded pressurizing block hole is disposed at an end portion of the screw through-hole in a coupling direction, wherein the coupling direction is perpendicular to the width direction of the base; and
a pressurizing block accommodated in the expanded pressurizing block hole is interposed between the bolt and the third coater shim, wherein the pressurizing block is configured to pressurize the third coater shim.

13. The die coater of claim 12, wherein the pressurizing block is configured to pressurizes portions of both side walls of the third coater shim.

14. A die coater comprising:
an upper block having a plurality of second liquid inlets;
a lower block coupled to the upper block; wherein the lower block includes a manifold configured to accommodate a first liquid; and
a plurality of coater shims interposed between the upper block and the lower block to form a first slit and a second slit, wherein the first slit and the second slit are spaced apart from each other,
wherein the plurality of coater shims include a first coater shim and a plurality second coater shims, wherein the first coater shim includes the first slit configured to discharge the first liquid accommodated in the manifold and each of the plurality of second coater shims include the second slit configured to discharge a second liquid supplied through an at least one of the plurality of second liquid inlets, and
wherein the first coater shim and each of the plurality of second coater shims have a same height, do not overlap vertically, and are disposed on a same surface between the upper block and the lower block.
